(19) United States
(12) Patent Application Publication
(10) Pub. No.: US 2013/0271718 A1
(43) Pub. Date: Oct. 17, 2013

(54) DISPLAY DEVICE

(71) Applicant: INNOLUX CORPORATION, Miao-Li County (TW)

(72) Inventors: Chien-Hung Chen, Miao-Li County (TW); Li-Chieh Hsu, Miao-Li County (TW); Pi-Ying Chuang, Miao-Li County (TW)

(73) Assignee: INNOLUX CORPORATION, Miao-Li County (TW)

(21) Appl. No.: 13/789,712

(22) Filed: Mar. 8, 2013

(30) Foreign Application Priority Data
Apr. 11, 2012 (TW) 101112807

(51) Int. Cl. C09K 19/02

(52) U.S. Cl. CPC C09K 19/0275
USPC 349/182

(57) ABSTRACT

A display device including a first substrate, a second substrate, and a liquid crystal layer is provided. The liquid crystal layer is disposed between the first substrate and the second substrate. The liquid crystal layer includes a liquid crystal mixture and a nano carbon material. The nano carbon material is distributed in the liquid crystal mixture.

This application claims the benefit of Taiwan application Serial No. 101112807, filed Apr. 11, 2012, the subject matter of which is incorporated herein by reference.

### BACKGROUND OF THE INVENTION

1. Field of the Invention

The invention relates in general to a display device, and more particularly to a display device including a nano carbon material.

2. Description of the Related Art

The blue phase liquid crystal is an optically isotropic superior liquid crystal material, with which an alignment film is not required. Furthermore, the response time of the blue phase liquid crystal is at sub-millisecond level. However, the range of the operating temperature of the blue phase liquid crystal is only within 1 K. To overcome this disadvantage, a polymer stabilized blue phase liquid crystal technology is proposed by industrial research personnel, with which technology the blue phase liquid crystal is fixed by a polymer network, such that the range of the operating temperature is increased from 1K to 60K. However, the high driving voltage and hysteresis remain issues of the blue phase liquid crystal to be solved.

Therefore, how to provide a blue phase liquid crystal display with a large range of operating temperature and a reduced driving voltage and hysteresis has become one of the important tasks for the industries.

### SUMMARY OF THE INVENTION

The invention is directed to a display device, in which a nano carbon material is distributed in a liquid crystal layer for reducing the driving voltage, improving the hysteresis, and increasing the transmittance.

According to an embodiment of the present invention, a display device including a first substrate, a second substrate, and a liquid crystal layer is provided. The liquid crystal layer is disposed between the first substrate and the second substrate. The liquid crystal layer includes a liquid crystal mixture and a nano carbon material. The nano carbon material is distributed in the liquid crystal mixture.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a display device according to an embodiment of the invention; and

FIG. 2 shows a curve diagram of transmittance vs. normalized driving voltage according to an embodiment of the invention.

### DETAILED DESCRIPTION OF THE INVENTION

A display device is provided in an embodiment of the disclosure. A nano carbon material is distributed in a liquid crystal layer for reducing the driving voltage, improving the hysteresis, and increasing the transmittance. However, the embodiments of the invention are for detailed descriptions only, not for limiting the scope of protection of the invention. Anyone who is skilled in the technology of the invention will be able to make necessary modifications or variations to the structures according to the needs in actual implementations of the invention.

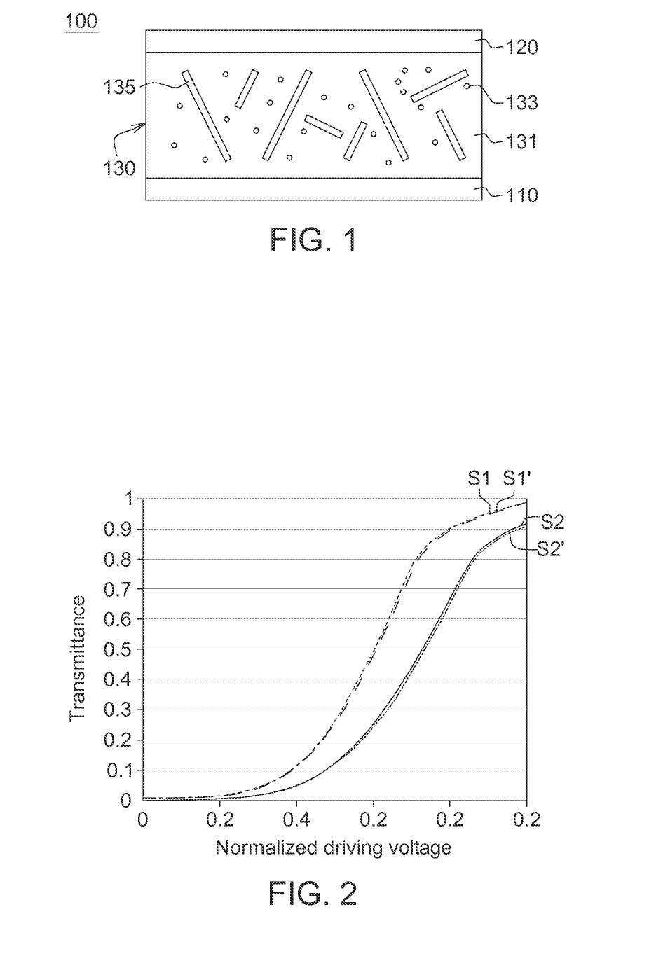

Referring to FIG. 1, a display device according to an embodiment of the invention is shown. The display device 100 includes a first substrate 110, a second substrate 120, and a liquid crystal layer 130. The liquid crystal layer 130 is disposed between the first substrate 110 and the second substrate 120. The liquid crystal layer 130 includes a liquid crystal mixture 131 and a nano carbon material 133. The nano carbon material 133 is distributed in the liquid crystal mixture 131. The liquid crystal layer 130 with the nano carbon material 133 distributed therein has a higher conductivity and hence can reduce the driving voltage effectively. Moreover, the nano carbon material 133 may easily be affected by an electric field. When a voltage is applied to the display device 100, the nano carbon material 133 distributed in the liquid crystal layer 130 helps to induce the arrangement of liquid crystal molecules of the liquid crystal mixture 131, and it helps to reduce the driving voltage effectively as well.

In an embodiment, the nano carbon material 133 is such as a carbon-based nano material, a carbon fiber, or a carbon graphite material. The carbon-based nano material being a nano carbon material with a hollowed structure is such as a carbon nanotube, a carbon sphere, or a carbon nano cone. The carbon fiber is such as a platelet graphite nano fiber or a turbostratic graphite nano fiber. The carbon graphite material is such as a graphite plate material. In an embodiment, the nano carbon material 133 may include a plurality of carbon nanotubes distributed in the liquid crystal mixture 131. In another embodiment, the nano carbon material 133 may include a plurality of platelet graphite nano fibers distributed in the liquid crystal mixture 131. In an alternative embodiment, the nano carbon material 133 may include a plurality of graphite plates distributed in the liquid crystal mixture 131. The size of the nano carbon material 133 is such as smaller than or equal to 100 nanometers (nm). When an external electric field is applied to the nano carbon materials 133 having different shapes, the external electric field induces the nano carbon materials 133 to trigger electric fields. The electric fields triggered by the nano carbon materials 133 having different shapes may have different field lines. Moreover, the electrical properties of the nano carbon materials 133 vary with the shape of the nano carbon materials 133 and the number of carbon rings in the structures of the nano carbon materials 133. Consequently, the nano carbon materials 133 having different shapes have different absorption rates for ions, or of which the induced electric fields have different field lines.

In an embodiment, the nano carbon material 133 such as includes a surface-modified nano carbon material. The surface of the surface-modified nano carbon material includes at least one functional group. The interaction between the functional group and the liquid crystal mixture 131 increases the dispersion of the nano carbon material 133 in the liquid crystal mixture 131. In an embodiment, the functional group is formed on the surface of the nano carbon material 133 by a plasma method to form a surface-modified nano carbon material. In an embodiment, the functional group such as includes a maleic anhydride group, expressed as chemical formula (1):

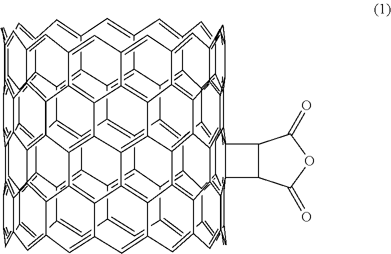

Wherein, the chemical formula (1) illustrates a single-wall carbon nanotube (SWCNT) whose surface is modified with a maleic anhydride group. However, in actual applications, the selections of the nano carbon material 133 and the modified functional group(s) are based on actual needs, and are not limited to the abovementioned materials. Any types of the nano carbon material 133 would do as long as the functional group(s) modifying the surface of the nano carbon material 133 helps the nano carbon material 133 to be mixed with the liquid crystal mixture 131 and helps to increase the dispersion of the nano carbon material 133 in the liquid crystal mixture 131.

In an embodiment, the nano carbon material 133 such as includes a nano carbon material whose surface is not modified.

In an embodiment, the weight percentage of the nano carbon material 133 in the liquid crystal mixture 131 is such as between 0.001˜1%.

In an embodiment, the liquid crystal mixture 131 is optically isotropic when no voltage is applied to the display device 100. In an embodiment, the liquid crystal mixture 131 may include a blue phase liquid crystal mixture. In another embodiment, the liquid crystal mixture 131 may include an optically isotropic liquid crystal mixture.

In an embodiment, the liquid crystal layer 130 further includes a polymer network 135 mixed with the liquid crystal mixture 131, wherein the nano carbon material 133 is distributed in the polymer network 135. In an embodiment, the liquid crystal mixture 131 is such as a blue phase liquid crystal mixture, the display device 100 is such as a blue phase liquid crystal display, and the polymer network 135 is able to fix the liquid crystal molecules of the blue phase liquid crystal mixture, so that the operating temperature range of the blue phase liquid crystal display is expanded. However, the blue phase liquid crystal mixture has a high polarity and may easily absorb impurities such as free ions or pollutants formed in the manufacturing process. The impurities and pollutants absorbed by the blue phase liquid crystal mixture may increase the driving voltage of the blue phase liquid crystal display. The nano carbon material 133 helps to absorb impurities and pollutants and effectively reduces the driving voltage and the hysteresis to increase the display quality of the blue phase liquid crystal display. In actual application, the selections of the types of the liquid crystal mixture 131 and the display device 100 are based on actual needs, and are not limited to the abovementioned types.

Manufacturing methods and measurement procedures for a liquid crystal mixture with a surface-modified nano carbon material distributed therein as in an experimental example and a liquid crystal mixture not without a surface-modified nano carbon material as in a comparative example are disclosed below:

### EXPERIMENTAL EXAMPLE

0.01 wt % of surface-modified carbon nanotubes are dissolved in a blue phase liquid crystal mixture containing a UV-light curing type polymer monomer. Next, the blue phase liquid crystal mixture is heated at a heating rate of 0.01˜5° C./min until the blue phase liquid crystal mixture becomes optically isotropic. Then, the mixture is exposed for 1-15 minutes by an exposure machine with a UV-light whose power is between 1-20 milliwatts (mW), so that the polymer monomer is cross-linked to form a polymer monomer network, and the surface-modified carbon nanotubes are fixed in the blue phase liquid crystal mixture. The exposed and cured mixture is a sample of an experimental example.

### COMPARATIVE EXAMPLE

The blue phase liquid crystal mixture containing a UV-light curried polymer monomer is heated at a heating rate of 0.01˜5° C./min until the blue phase liquid crystal mixture becomes optically isotropic. Next, the mixture is exposed for 1˜15 minutes by an exposure machine with a UV-light whose power is between 1˜20 milliwatts (mW), so that the polymer monomer is cross-linked to form a polymer monomer network. The exposed and cured mixture is a sample of a comparative example.

### SAMPLE MEASUREMENT

After a wire is soldered to a sample, a power controller applies a voltage of 0˜140 volt (V) to the electrode of the sample, and a luminance meter measures the transmittance of the sample when receiving different magnitudes of the voltage. The voltage is continually boosted from 0 volt to 140 volts and then stepped down to 0 volt, and the transmittance is measured at the same time, so that a boosting curve corresponding to the boosting part and a step-down curve corresponding to the step-down part are respectively obtained. The boosting curve denotes a voltage vs. transmittance relationship during the process when the voltage is boosted from 0 volt to 140 volts. The step-down curve denotes a voltage vs. transmittance relationship during the process when the voltage is stepped down from 140 volts to 0 volt.

Referring to FIG. 2, a curve diagram of transmittance vs. normalized driving voltage according to an embodiment of the invention is shown. Curves S1 and S1′ denote the relationship of a driving voltage vs. the transmittance of a sample of the experimental example. Curves S2 and S2′ denote the relationship of a driving voltage vs. the transmittance of a sample of the comparative example. As indicated in FIG. 2, under the same magnitude of the driving voltage, the sample with 0.01 wt % of surface-modified carbon nanotubes distributed therein (curve S1) obviously has higher transmittance than the sample without the surface-modified carbon nanotubes (curve S2). In an embodiment, the transmittance is increased by about 7˜100%. For example, when the normalized driving voltage is set at 0.5, in comparison to the transmittance of the sample without the surface-modified carbon nanotubes, the transmittance of the sample with 0.01 wt % of surface-modified carbon nanotubes distributed therein is increased by 100%.

In comparison to the sample without surface-modified carbon nanotubes, the sample with the surface-modified carbon nanotubes distributed therein has a smaller hysteresis. The hysteresis is denoted by the difference between the transmittance of the boosting part and the transmittance of the step-down part at a normalized driving voltage of 0.5. The larger the difference is, the worse the hysteresis is. In an embodiment, with the surface-modified carbon nanotubes being distributed in the sample, the transmittance difference is decreased to be about ¼˜ 1/7 of the original value. As indicated in FIG. 2, the curve S1 corresponds to the boosting part of the whole curve, which denotes the normalized driving voltage vs. transmittance relationship of a sample of the experimental example, and the curve S1 is obtained as the normalized driving voltage is boosted from 0 to 1. The curve S1′ corresponds to the step-down part of the whole curve, which denotes the normalized driving voltage vs. transmittance relationship corresponding to the sample of the experimental example, and the curve S1′ is obtained as the normalized driving voltage is stepped down from 1 to 0. The curve S2 corresponds to the boosting part of the whole curve, which denotes the normalized driving voltage vs. transmittance relationship corresponding to t a sample of the comparative example. The curve S2′ corresponds to the step-down part of the whole curve, which denotes the normalized driving voltage vs. transmittance relationship corresponding to the sample of the comparative example. As indicated in FIG. 2, when the normalized driving voltage is 0.5, the transmittance difference between curves S1 and S1′ of the sample with 0.01 wt % of surface-modified carbon nanotubes distributed in the experimental example is 0.02, and the transmittance difference between curves S2 and S2′ of the sample not without surface-modified carbon nanotubes in the comparative example is 0.0914. With the surface-modified carbon nanotubes distributed in the sample, the transmittance difference is decreased to be about 1/4.5 of the original value.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a first substrate;
a second substrate; and
a liquid crystal layer disposed between the first substrate and the second substrate, wherein the liquid crystal layer comprises:
a liquid crystal mixture; and
a nano carbon material distributed in the liquid crystal mixture.

2. The display device according to claim 1, wherein the nano carbon material comprises a plurality of carbon-based nano materials distributed in the liquid crystal mixture.

3. The display device according to claim 1, wherein the nano carbon material comprises a plurality of carbon fibers distributed in the liquid crystal mixture.

4. The display device according to claim 1, wherein the nano carbon material comprises a plurality of carbon graphite materials distributed in the liquid crystal mixture.

5. The display device according to claim 1, wherein the nano carbon material comprises a surface-modified nano carbon material.

6. The display device according to claim 5, wherein a surface of the surface-modified nano carbon material comprises at least one functional group comprising a maleic anhydride group.

7. The display device according to claim 1, wherein the nano carbon material comprises a non-surface-modified nano carbon material.

8. The display device according to claim 1, wherein the weight percentage of the nano carbon material in the liquid crystal mixture is between 0.001˜1%.

9. The display device according to claim 1, wherein the liquid crystal mixture comprises a blue phase liquid crystal mixture.

10. The display device according to claim 1, wherein the liquid crystal layer further comprises a polymer network mixed with the liquid crystal mixture, and the nano carbon material is distributed in the polymer network.

11. The display device according to claim 1, wherein the liquid crystal mixture is optically isotropic when no voltage is applied to the display device.
